(19) United States
(12) Patent Application Publication
(10) Pub. No.: US 2024/0330785 A1
(43) Pub. Date: Oct. 3, 2024

(54) AIRCRAFT MANAGEMENT SYSTEM AND AIRCRAFT MANAGEMENT METHOD

(71) Applicant: HONDA MOTOR CO., LTD., Tokyo (JP)

(72) Inventors: Yuho Yamazaki, Wako-shi (JP); Mitsutake Ando, Wako-shi (JP)

(21) Appl. No.: 18/442,983

(22) Filed: Feb. 15, 2024

(30) Foreign Application Priority Data
Mar. 28, 2023 (JP) 2023-052063

(51) Int. Cl. G06Q 10/02

(52) U.S. Cl. CPC G06Q 10/025

(57) ABSTRACT

An aircraft management system includes: a departure time moving-forward confirmation section that transmits departure time moving-forward confirmation information to a first user terminal when a wait time from a first user arrival time until a scheduled departure time of a target flight from a first point is a first predetermined time period or more, the departure time moving-forward confirmation information inquiring whether or not it is desired to move forward the departure time of the target flight; and a departure time moving-forward arrangement section that arranges moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

### INCORPORATION BY REFERENCE

The present application claims priority under 35 U.S.C.§ 119 to Japanese Patent Application No. 2023-052063 filed on Mar. 28, 2023. The content of the application is incorporated herein by reference in its entirety.

### BACKGROUND OF THE INVENTION

### Field of the Invention

The present invention relates to an aircraft management system and an aircraft management method.

### Description of the Related Art

Conventionally, a technique has been disclosed in which an itinerary including traveling by VTOL (Vertical Take-Off and Landing) aircraft is arranged in response to a request from a passenger, it is determined whether or not to wait for an additional passenger when it is confirmed that the passenger is aboard the VTOL aircraft, and the VTOL aircraft is caused to take off when a predetermined condition is fulfilled (for example, see the Specification of U.S. Pat. No. 10,837,786).

When boarding an aircraft, a user of the aircraft generally sets off for a port that is a flight departure point well in advance, because a boarding procedure takes more time than procedures for other public transportations such as railroads. Accordingly, there are some cases where a user arrives at a port that is a flight departure point too early, and the time period that the user spends in the port on waiting for takeoff lengthens. Moreover, the time period that the user spends in the port on waiting for takeoff also lengthens when the flight is delayed as a result of waiting for an additional passenger as in the related art, or due to bad weather or the like. In such cases, efficient traveling of the user is hindered. However, the related art does not take user efficiency into consideration and therefore has room for improvement.

The present invention has been made in light of such background, and an object thereof is to provide an aircraft management system and an aircraft management method that can support a user in efficient traveling by aircraft.

### SUMMARY OF THE INVENTION

A first aspect to achieve the object is an aircraft management system including: a traveling plan recognition section that recognizes a traveling plan of a first user, based on schedule information on the first user, the schedule information being transmitted from a first user terminal used by the first user; a first user arrival time recognition section that recognizes a first user arrival time when the traveling plan includes traveling via a target flight from a first point to a second point, the first user arrival time being a time at which the first user arrives at the first point; a departure time moving-forward confirmation section that transmits departure time moving-forward confirmation information to the first user terminal when a wait time from the first user arrival time until a scheduled departure time of the target flight from the first point is a first predetermined time period or more, the departure time moving-forward confirmation information inquiring whether or not it is desired to move forward the departure time of the target flight; and a departure time moving-forward arrangement section that arranges moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

The aircraft management system of the first aspect may further includes: a ground transportation operation status information acquisition section that acquires ground transportation operation status information indicating operation status of a ground transportation that is available for traveling from the second point; and a target ground transportation recognition section that recognizes a target ground transportation, based on the traveling plan and the ground transportation operation status information, the target ground transportation being available over a traveling route from the second point to a destination in the traveling plan, wherein the departure time moving-forward confirmation section may be configured to transmit, to the first user terminal, the departure time moving-forward confirmation information including information on the target ground transportation.

The aircraft management system of the first aspect may further includes: a flight status information acquisition section that acquires flight status information indicating flight status of a flight from the first point to the second point; and an alternative flight checking section that checks, based on the flight status information, whether or not it is possible to arrange an alternative flight of the target flight for a second user who has booked use of the target flight, wherein the departure time moving-forward confirmation section may be configured to transmit the departure time moving-forward confirmation information to the first user terminal when it is confirmed by the alternative flight checking section that it is possible to arrange the alternative flight for the second user.

In the aircraft management system of the first aspect, the departure time moving-forward confirmation section may be configured to transmit, to the first user terminal, the departure time moving-forward confirmation information including information on an additional fee to be incurred when the target flight is used with the departure time being moved forward.

A second aspect to achieve the object is an aircraft management system including: a traveling plan recognition section that recognizes a traveling plan of a first user, based on schedule information on the first user, the schedule information being transmitted from a first user terminal used by the first user; a first user arrival time recognition section that recognizes a first user arrival time when the traveling plan includes traveling via a target flight from a first point to a second point, the first user arrival time being a time at which the first user arrives at the first point; a second user arrival time recognition section that recognizes a second user arrival time that is a time at which a second user arrives at the first point, the second user having booked use of the target flight; a departure time pushing-back confirmation section that transmits departure time pushing-back confirmation information to the first user terminal when a delay time from a scheduled departure time of the target flight from the first point until the second user arrival time is a second predetermined time period or more, the departure time pushing-back confirmation information inquiring whether or not it is permitted to push back the departure time of the target flight according to the delay time; and a departure time pushing-back arrangement section that arranges pushing back of the departure time of the target flight when departure time pushing-back approval information is received, the departure time pushing-back approval information being transmitted from the first user terminal in response to reception of the departure time pushing-back confirmation information, the departure time pushing-back approval information approving pushing back of the departure time of the target flight.

The aircraft management system of the second aspect may further includes: a ground transportation operation status information acquisition section that acquires ground transportation operation status information indicating operation status of a ground transportation that is available for traveling from the second point; and a target ground transportation recognition section that recognizes a target ground transportation, based on the traveling plan and the ground transportation operation status information, the target ground transportation being available over a traveling route from the second point to a destination in the traveling plan, wherein the departure time pushing-back confirmation section may be configured to transmit, to the first user terminal, the departure time pushing-back confirmation information including information on the target ground transportation.

In the aircraft management system of the second aspect, the departure time pushing-back confirmation section may be configured to transmit, to the first user terminal, the departure time pushing-back confirmation information including information on an incentive to be gained when the target flight is used with the departure time being pushed back.

A third aspect to achieve the object is an aircraft management method executed by a computer, including: a traveling plan recognition step of recognizing a traveling plan of a first user, based on schedule information on the first user, the schedule information being transmitted from a first user terminal used by the first user; a first user arrival time recognition step of recognizing a first user arrival time when the traveling plan includes traveling via a target flight from a first point to a second point, the first user arrival time being a time at which the first user arrives at the first point; a departure time moving-forward confirmation step of transmitting departure time moving-forward confirmation information to the first user terminal when a wait time from the first user arrival time until a scheduled departure time of the target flight from the first point is a first predetermined time period or more, the departure time moving-forward confirmation information inquiring whether or not it is desired to move forward the departure time of the target flight; and a departure time moving-forward arrangement step of arranging moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

A fourth aspect to achieve the object is an aircraft management method executed by a computer, including: a traveling plan recognition step of recognizing a traveling plan of a first user, based on schedule information on the first user, the schedule information being transmitted from a first user terminal used by the first user; a first user arrival time recognition step of recognizing a first user arrival time when the traveling plan includes traveling via a target flight from a first point to a second point, the first user arrival time being a time at which the first user arrives at the first point; a second user arrival time recognition step of recognizing a second user arrival time that is a time at which a second user arrives at the first point, the second user having booked use of the target flight; a departure time pushing-back confirmation step of transmitting departure time pushing-back confirmation information to the first user terminal when a delay time from a scheduled departure time of the target flight from the first point until the second user arrival time is a second predetermined time period or more, the departure time pushing-back confirmation information inquiring whether or not it is permitted to push back the departure time of the target flight according to the delay time; and a departure time pushing-back arrangement step of arranging pushing back of the departure time of the target flight when departure time pushing-back approval information is received, the departure time pushing-back approval information being transmitted from the first user terminal in response to reception of the departure time pushing-back confirmation information, the departure time pushing-back approval information approving pushing back of the departure time of the target flight.

According to the aircraft management system and the aircraft management method, it is possible to support a user in efficient traveling by aircraft.

### BRIEF DESCRIPTION OF THE DRAWINGS

FIG. 1 is an explanatory diagram of a response provided by an aircraft management system, in which a departure time of a flight is moved forward;

FIG. 2 is an explanatory diagram of a response provided by the aircraft management system, in which the departure time of the flight is pushed back;

FIG. 3 is a configuration diagram of the aircraft management system;

FIG. 4 is a first flowchart of a process of changing the departure time of the flight;

FIG. 5 is a second flowchart of the process of changing the departure time of the flight; and

FIG. 6 is a third flowchart of the process of changing the departure time of the flight.

### DETAILED DESCRIPTION OF THE PREFERRED EMBODIMENTS

### 1. Moving Forward and Pushing Back of Departure Time of Flight by Aircraft Management System

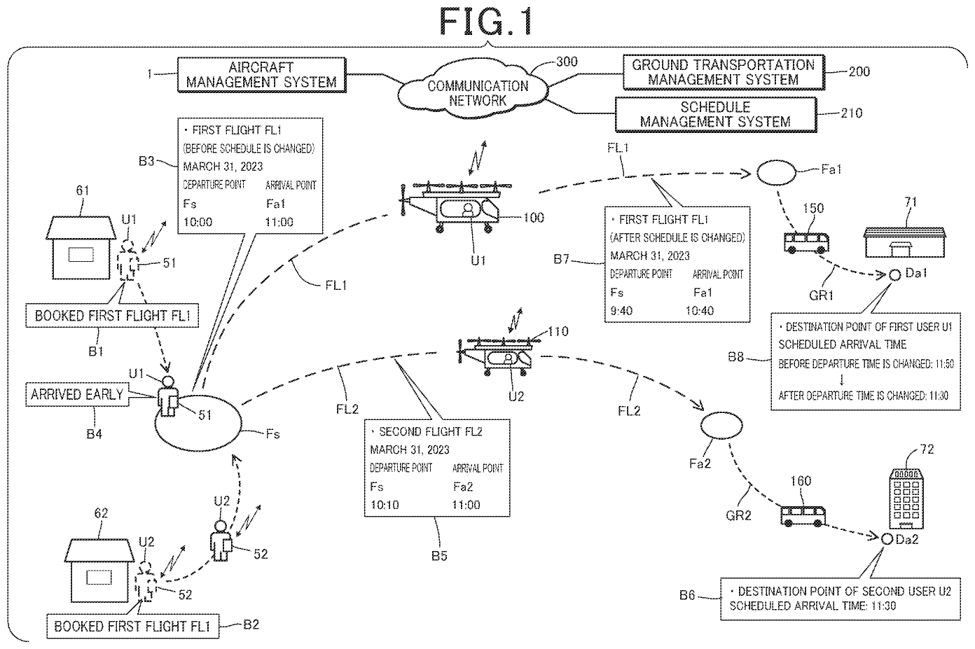

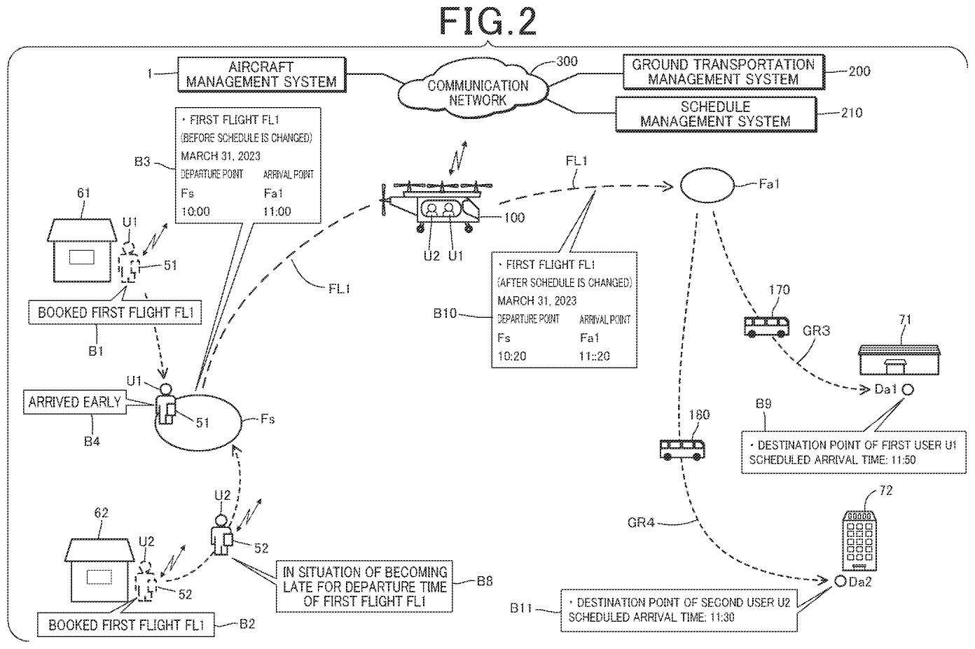

With reference to FIGS. 1 and 2, a description is given of responses provided by an aircraft management system 1 according to a present embodiment, in which a departure time of a first flight FL1 (corresponding to “target flight” of the present disclosure) is moved forward and pushed back, respectively.

As indicated in callout B3, the first flight FL1 is scheduled to depart at 10:00 from a port Fs that is a departure point, and to arrive at 11:00 at a port Fa1 that is an arrival point, by using an aircraft 100. The aircraft 100 is, for example, an eVTOL (electric Vertical Take-Off and Landing) aircraft. The port Fs corresponds to “first point” of the present disclosure, and the port Fa1 corresponds to “second point” of the present disclosure. A first user U1 and a second user U2 have already booked the first flight FL1, as indicated in callouts B1, B2.

An aircraft booking app (application program) and a schedule management app are installed in each of a first user terminal 51 used by the first user U1 and a second user terminal 52 used by the second user U2. The first user U1 and the second user U2 book an aircraft by using the aircraft booking app and manage a schedule including a traveling plan by using the schedule management app. The first user terminal 51 and the second user terminal 52 are, for example, smartphones, mobile telephones, tablet terminals, or the like. In FIGS. 1 and 2, the first user U1 has left home 61 and already arrived at the port Fs, while the second user U2 has left home 62 and is traveling on the way to the port Fs.

The aircraft management system 1 communicates with a ground transportation management system 200, a schedule management system 210, the first user terminal 51, the second user terminal 52, and a management-target aircraft (including aircraft 100, 110) via a communication network 300. The schedule management system 210 stores schedule information on the first user U1 transmitted from the first user terminal 51, and schedule information on the second user U2 transmitted from the second user terminal 52. The aircraft management system 1 recognizes that each of the first user U1 and the second user U2 has a traveling plan using the first flight FL1, by accessing the schedule management system 210 and acquiring the schedule information on the first user U1 and the second user U2.

The aircraft management system 1 recognizes respective current positions of the first user U1 and the second user U2, by acquiring position information transmitted from the first user terminal 51 and position information transmitted from the second user terminal 52. The aircraft management system 1 recognizes a time (first user arrival time) at which the first user U1 arrives at the port Fs, and a time (second user arrival time) at which the second user U2 arrives at the port Fs, based on the current positions of the first user U1 and the second user U2, respectively.

FIG. 1 illustrates a situation in which the first user U1 arrives at the port Fs at 9:30, which is earlier than 10:00 that is a scheduled departure time of the first flight FL1, and at the time point, the second user U2 has not yet arrived at the port Fs. In such a situation, when the first user U1 uses the first flight FL1 as is scheduled, a wait time that the first user U1 spends in the port Fs on waiting lengthens, so that traveling efficiency of the first user U1 decreases.

Accordingly, the aircraft management system 1 executes a process of supporting the first user U1 in efficient traveling, by moving forward the departure time of the first flight FL1 and thus reducing the wait time of the first user U1. At the time, the aircraft management system 1 arranges, for the second user U2, a second flight FL2 that is available to the second user U2 instead of the first flight FL1.

In FIG. 1, as indicated in callout B7, the departure time of the first flight FL1 is moved forward from original 10:00 to 9:40. The first user U1 uses a ground transportation 150, such as a shared vehicle, to travel over a traveling route GR from the port Fa1, which is the arrival point of the first flight FL1, up to a final destination point Da1 (in the vicinity of a facility 71). As a result of the departure time of the first flight FL1 being moved forward, the scheduled arrival time of the first user U1 at the destination point Da1 is brought forward from 11:50 to 11:30.

For the second user U2, the aircraft management system 1 extracts and arranges the second flight FL2 that makes it possible to arrive at a destination point Da2 (in the vicinity of a facility 72) of the second user U2 by a scheduled arrival time of 11:30, as indicated in callout B6, through traveling combined with traveling over a traveling route GR2 by using a ground transportation 160, such as a shared vehicle. The aircraft management system 1 extracts the second flight FL2, based on the traveling plan including the destination point Da2 of the second user U2, operation status information on ground transportations acquired by accessing the ground transportation management system 200, and flight status of managed aircrafts.

Next, FIG. 2 illustrates a situation in which the first user U1 arrives at the port Fs before 10:00, which is the departure time of the first flight FL1, but arrival of the second user U2 at the port Fs is delayed, as indicated in callout B8. In such a situation, if the departure time of the first flight FL1 is unconditionally pushed backed in order to wait for the second user U2 to arrive, the wait time that the first user U1 spends in the port Fs on waiting lengthens, so that the traveling efficiency of the first user U1 decreases.

Accordingly, the aircraft management system 1 recognizes the destination point Da1 (in the vicinity of the facility 71) of the first user U1, which is recognized from the traveling plan of the first user U1, as indicated in callout B9, and recognizes a ground transportation 170, such as a shared vehicle, that is available over a traveling route GR3 (which may be the same as GR1 shown in FIG. 1, in some cases) up to the destination point Da1 by accessing the ground transportation management system 200.

The aircraft management system 1 then shows information on the ground transportation 170 and inquires whether or not the first user U1 permits pushing back of the departure time of the first flight FL1, and when the first user U1 approves, pushes back the departure time of the first flight FL1. In FIG. 2, as indicated in callout B10, the departure time of the first flight FL1 is pushed back from original 10:00 to 10:20. The second user U2 uses a ground transportation 180, such as a shared vehicle, to travel over a traveling route GR4 from the port Fa1 up to the destination point Da2 indicated in callout B11. In such a case, an efficient flight can be carried out by maintaining the passenger load factor of the aircraft 100. Note that pushing back of the departure time of the first flight FL1 may be permitted on condition that a next scheduled flight of the aircraft 100 that is used for the first flight FL1 is not affected even if the departure time of the first flight FL1 is pushed back.

### 2. Configuration of Aircraft Management System

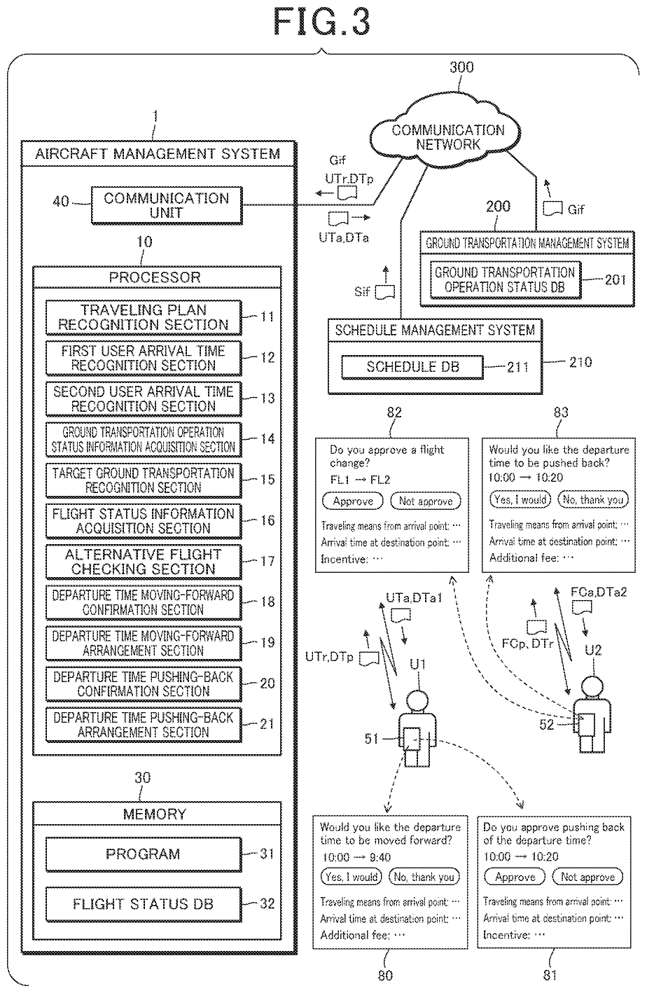

With reference to FIG. 3, a configuration of the aircraft management system 1 is described. The aircraft management system 1 is a computer system including a processor 10, a memory 30, a communication unit 40, and the like. The aircraft management system 1 performs communication via the communication network 300 as described above.

The ground transportation management system 200 includes a ground transportation operation status DB (database) in which operation status of ground transportations, such as a courtesy vehicle, a shared vehicle, a bus, and a railroad, is recorded. The schedule management system 210 receives the schedule information on the first user U1 transmitted from the first user terminal 51 and the schedule information on the second user U2 transmitted from the second user terminal 52 as described above, and records the schedule information in a schedule DB 211.

The memory 30 stores a program 31 for control of the aircraft management system 1, a flight status DB (database) 32 in which flight status information on flights managed by the aircraft management system 1 is recorded, and the like. The program 31 may be read from a recording medium (magnetic disk, optical disk, flash memory, or the like) and stored in the memory 30, or may be downloaded from an external server or the like via the communication network 300 and stored in the memory 30. Booking information on the first flight FL1 that the first user U1 and the second user U2 have booked by using the aircraft booking app as described above is also recorded in the flight status DB 32.

By reading and executing the program 31, the processor 10 functions as a traveling plan recognition section 11, a first user arrival time recognition section 12, a second user arrival time recognition section 13, a ground transportation operation status information acquisition section 14, a target ground transportation recognition section 15, a flight status information acquisition section 16, an alternative flight checking section 17, a departure time moving-forward confirmation section 18, a departure time moving-forward arrangement section 19, a departure time pushing-back confirmation section 20, and a departure time pushing-back arrangement section 21. The processor corresponds to “computer” of the present disclosure.

A process executed by the traveling plan recognition section 11 corresponds to “traveling plan recognition step” in the aircraft management method of the present disclosure, and a process executed by the first user arrival time recognition section 12 corresponds to “first user arrival time recognition step” in the aircraft management method of the present disclosure. A process executed by the second user arrival time recognition section 13 corresponds to “second user arrival time recognition step” in the aircraft management method of the present disclosure. A process executed by the departure time moving-forward confirmation section 18 corresponds to “departure time moving-forward confirmation step” in the aircraft management method of the present disclosure, and a process executed by the departure time moving-forward arrangement section 19 corresponds to “departure time moving-forward arrangement step” in the aircraft management method of the present disclosure. A process executed by the departure time pushing-back confirmation section 20 corresponds to “departure time pushing-back confirmation step” in the aircraft management method of the present disclosure, and a process executed by the departure time pushing-back arrangement section 21 corresponds to “departure time pushing-back arrangement step” in the aircraft management method of the present disclosure.

The traveling plan recognition section 11 acquires the schedule information Sif on the first user U1 and the second user U2 by accessing the schedule DB 211 of the schedule management system 210 and, based on the schedule information Sif, recognizes the respective traveling plans of the first user U1 and the second user U2. In the examples in FIGS. 1 and 2, the traveling plan recognition section 11 recognizes the traveling plans of the first user U1 and the second user U2, each including traveling by using the first flight FL1.

The first user arrival time recognition section 12 acquires position detection information transmitted from the first user terminal 51 and, based on the position detection information, recognizes (estimates) a time (first user arrival time) at which the first user U1 arrives at the port Fs. The first user terminal 51 detects a current position of the first user terminal 51 by using a position sensor, such as a GNSS (Global Navigation Satellite System) sensor, and transmits the position detection information to the aircraft management system 1. Note that information on an expected time of arrival of the first user U1 at the port Fs may be transmitted from the first user terminal 51 to the aircraft management system 1, and the first user arrival time recognition section 12 may recognize the first user arrival time, based on the information on the expected time of arrival.

Similarly, the second user arrival time recognition section 13 recognizes (estimates) a time (second user arrival time) at which the second user U2 arrives at the port Fs, based on position detection information transmitted from the second user terminal 52. Note that information on an expected time of arrival of the second user U2 at the port Fs may be transmitted from the second user terminal 52 to the aircraft management system 1, and the second user arrival time recognition section 13 may recognize the second user arrival time, based on the information on the expected time of arrival.

The ground transportation operation status information acquisition section 14 acquires ground transportation operation status information Gif indicating operation status of a ground transportation that is available from the port Fa1, which is the arrival point of the first flight FL1, and operation status of a ground transportation that is available from a port Fa2 that is an arrival point of the second flight FL2, by accessing the ground transportation operation status DB 210 of the ground transportation management system 200.

When the departure time of the first flight FL1 is moved forward in response to early arrival of the first user U1 at the port Fs and the second flight FL2 is arranged for the second user U2 instead of the first flight FL1 as illustrated in FIG. 1, the target ground transportation recognition section 15 recognizes the ground transportation 160 (target ground transportation) that is available from the port Fa2, which is the arrival point of the second flight FL2, by referring to the ground transportation operation status information Gif.

Moreover, when the departure time of the first flight FL1 is pushed back in response to late arrival of the second user U2 at the port Fs as illustrated in FIG. 2, the target ground transportation recognition section 15 recognizes the ground transportation 170 (target ground transportation) that is available to the first user U1 from the port Fa1, which is the arrival point of the first flight FL1, by referring to the ground transportation operation status information Gif.

The flight status information acquisition section 16 acquires flight status information on a flight having the port Fs as a departure point, by referring to the flight status DB 32. When the departure time of the first flight FL1 is moved forward as illustrated in FIG. 1, the alternative flight checking section 17 checks whether or not it is possible to arrange, for the second user U2 who becomes unable to board the first flight FL1, the second flight FL2 that makes it possible to use, from the port Fa2, which is the arrival point of the flight, the ground transportation 160 that can arrive at the destination point Da2 of the second user U2 by the scheduled arrival time of 11:30.

Processes by the departure time moving-forward confirmation section 18, the departure time moving-forward arrangement section 19, the departure time pushing-back confirmation section 20, and the departure time pushing-back arrangement section 21 will be described later.

### 3. Process of Changing Departure Time of Flight

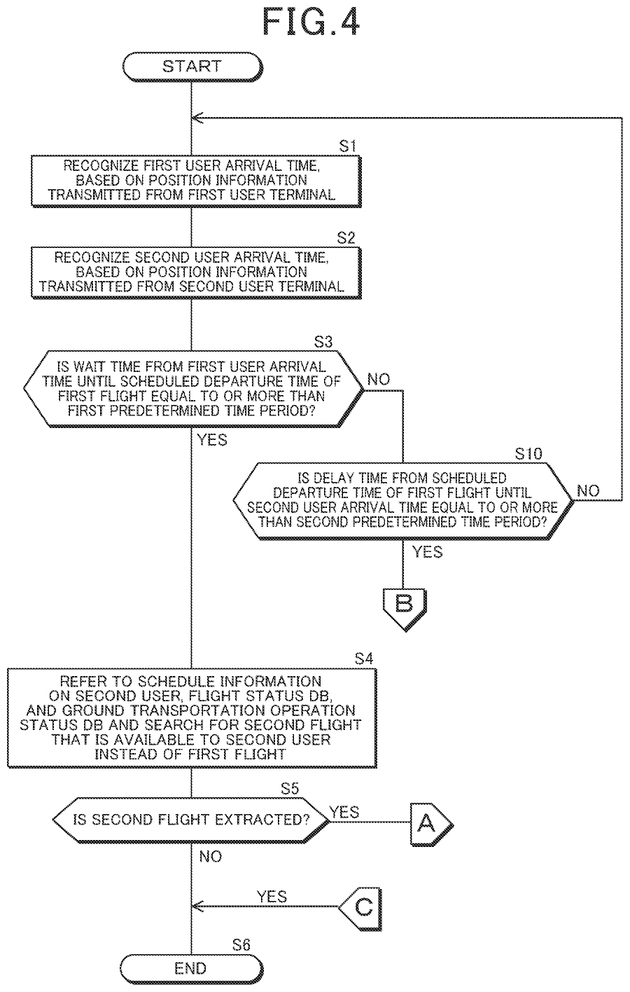

By following flowcharts shown in FIGS. 4 to 6, a description is given of a procedure for a process of changing the departure time of the first flight FL1, executed by the aircraft management system 1 in the situations shown in FIGS. 1 and 2. When the first user U1 and the second user U2 have booked use of the first flight FL1 as shown in FIGS. 1 and 2, the aircraft management system 1 executes the process according to the flowcharts shown in FIGS. 4 to 6.

In step S1 in FIG. 4, the first user arrival time recognition section 12 recognizes a time (first user arrival time) at which the first user U1 arrives at the port Fs, which is the departure point of the first flight FL1, based on the position information, or arrival time notification information, transmitted from the first user terminal 51. In subsequent step S2, the second user arrival time recognition section 13 recognizes a time (second user arrival time) at which the second user U2 arrives at the port Fs, based on the position information, or arrival time notification information, transmitted from the second user terminal 52.

Next step S3 is a process by the departure time moving-forward confirmation section 18. In step S3, the departure time moving-forward confirmation section 18 determines whether or not the wait time from the first user arrival time until the scheduled departure time of the first flight FL1 is a first predetermined time period or more. The departure time moving-forward confirmation section 18 moves the process to step S4 when the wait time is the first predetermined time period or more, and moves the process to step S10 when the wait time is less than the first predetermined time period.

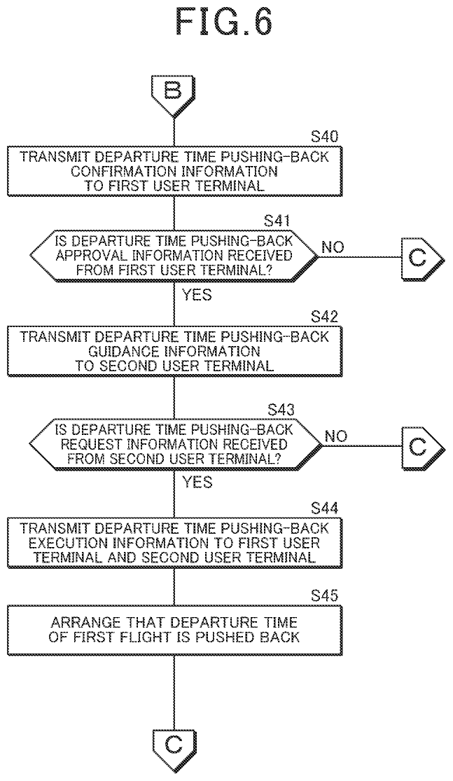

Step S10 is a process by the departure time pushing-back confirmation section 20. In step S10, the departure time pushing-back confirmation section 20 determines whether or not a delay time from the scheduled departure time of the first flight FL1 until the second user arrival time is a second predetermined time period or more. The departure time pushing-back confirmation section 20 moves the process to step S40 in FIG. 6 when the delay time is the second predetermined time period or more, and moves the process to step S1 when the delay time is less than the second predetermined time period.

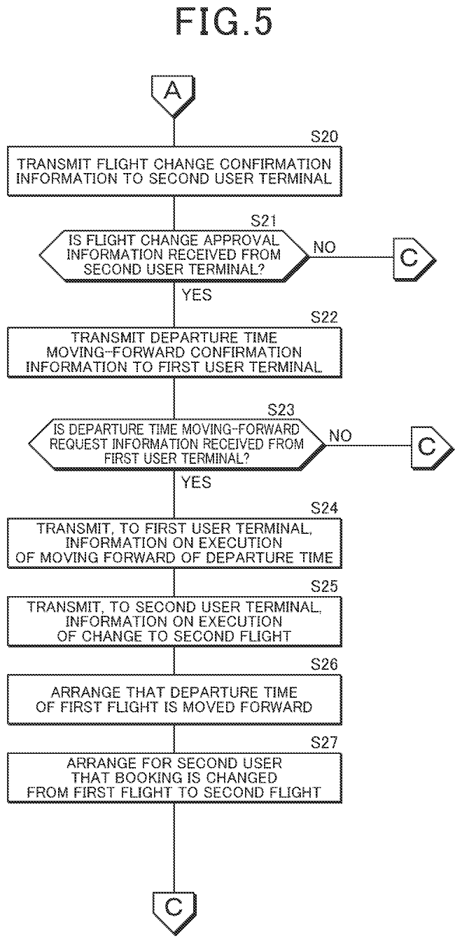

Step S4 to step S27 in FIG. 5 are processes corresponding to the moving forward of the departure time of the first flight FL1 illustrated in FIG. 1. In step S4, the alternative flight checking section 17 refers to the schedule information Sif on the second user U2, the flight status DB 32, and the ground transportation operation status DB 201 and searches for the second flight FL2 that is available to the second user U2 instead of the first flight FL1. In subsequent step S5, the alternative flight checking section 17 moves the process to step S20 in FIG. 5 when the second flight FL2 is extracted, and moves the process to step S6 when the second flight FL2 is not extracted.

In step S20 in FIG. 5, the departure time moving-forward confirmation section 18 transmits flight change confirmation information FCa to the second user terminal 52, as shown in FIG. 3. The flight change confirmation information FCa includes information on a ground transportation that is available from the port Fa2, which is the arrival point of the second flight FL2, and information on an incentive that can be gained when a flight change is approved.

The second user terminal 52 displays a permission confirmation screen 82 to confirm whether or not the flight change is permitted, in response to reception of the flight change confirmation information FCa, and the second user U2 performs an operation of choosing whether or not to approve the flight change. Displayed on the permission confirmation screen 82 is information involved when the flight for the second user U2 to use is changed (from the first flight FL1 to the second flight FL2) as shown in FIG. 1, and the information includes the ground transportation 160 that is traveling means available from the port Fa2, which is the arrival point of the second flight FL2, an arrival time (expected arrival time) expected when the second user U2 travels from the port Fa2 up to the final destination point Da2 by using the ground transportation 160, and the incentive that can be gained when the flight change is approved. When the second user U2 performs an operation of approving the flight change, flight change approval information FCp is transmitted from the second user terminal 52 to the aircraft management system 1.

In next step S21, the departure time moving-forward confirmation section 18 moves the process to step S22 when the flight change approval information FCp is received from the second user terminal 52, and moves the process to step S6 in FIG. 4 when the flight change approval information FCp is not received from the second user terminal 52. In subsequent step S22, the departure time moving-forward confirmation section 18 transmits departure time moving-forward confirmation information UTa to the first user terminal 51. The departure time moving-forward confirmation information Uta includes information on a ground transportation that is available from the port Fa1, and information on an additional fee to be incurred when the departure time is moved forward.

The first user terminal 51 displays a desire confirmation screen 80 to confirm whether or not moving forward of the departure time is desired, in response to reception of the departure time moving-forward confirmation information UTa, and the first user U1 confirms the desire confirmation screen 80 and performs an operation of choosing whether or not to desire moving forward of the departure time of the first flight FL1. Displayed on the desire confirmation screen 80 is information involved when the departure time of the first flight FL1 is moved forward (from 10:00 to 9:40) as shown in FIG. 1, and the information includes the ground transportation 150 that is traveling means available from the port Fa1, which is the arrival point of the first flight FL1, an arrival time (expected arrival time) expected when the first user U1 travels from the port Fa1 up to the final destination point Da1 by using the ground transportation, and the additional fee required to move forward the departure time. When the first user U1 performs an operation of desiring moving forward of the departure time, departure time moving-forward request information UTr is transmitted from the first user terminal 51 to the aircraft management system 1.

In subsequent step S23, the departure time moving-forward confirmation section 18 determines whether or not the departure time moving-forward request information UTr transmitted from the first user terminal 51 is received. The departure time moving-forward confirmation section 18 moves the process to step S24 when the departure time moving-forward request information UTr is received, and moves the process to step S6 in FIG. 4 when the departure time moving-forward request information UTr is not received.

In step S24, the departure time moving-forward confirmation section 18 transmits, to the first user terminal 51, execution information notifying that moving forward of the departure time of the first flight FL1 will be executed. In next step S25, the departure time moving-forward confirmation section 18 transmits, to the second user terminal 52, execution information notifying that a change from the first flight FL1 to the second flight FL2 will be executed.

In subsequent step S26, the departure time moving-forward arrangement section 19 executes moving forward of the departure time of the first flight FL1. In next step S27, the departure time moving-forward arrangement section 19 arranges for the second user U2 that the booking is changed from the first flight FL1 to the second flight FL2, and then moves the process to step S6 in FIG. 4. Thus, in the example shown in FIG. 1, the departure time of the first flight FL1 is moved forward from 10:00 to 9:40, and the flight for the second user U2 to use is changed from the first flight FL1 to the second flight FL2.

Next, steps S40 to S45 in FIG. 6 are processes corresponding to the pushing back of the departure time of the first flight FL1 illustrated in FIG. 2. In step S40, the departure time pushing-back confirmation section 20 transmits departure time pushing-back confirmation information DTa1 to the first user terminal 51. The departure time pushing-back confirmation information DTa1 includes information on a ground transportation that is available from the port Fa1, which is the arrival point of the first flight FL1, and information on an incentive that can be gained when pushing back of the departure time of the first flight FL1 is approved.

The first user terminal 51 displays a permission confirmation screen 81 to confirm whether or not pushing back of the departure time is permitted, in response to reception of the departure time pushing-back confirmation information DTa1, and the first user U1 confirms the permission confirmation screen 81 and performs an operation of choosing whether or not to approve pushing back of the departure time of the first flight FL1. Displayed on the permission confirmation screen 81 is information involved when the departure time of the first flight FL1 is pushed back (from 10:00 to 10:20) as shown in FIG. 2, and the information includes the ground transportation 170 that is traveling means available to the first user U1 from the port Fa1, which is the arrival point of the first flight FL1, an arrival time (expected arrival time) expected when the first user U1 travels from the port Fa1 up to the final destination point Da1 by using the ground transportation 170, and the incentive that can be gained when pushing back of the departure time is approved. When the first user U1 performs an operation of approving pushing back of the departure time, departure time pushing-back approval information DTp is transmitted from the first user terminal 51 to the aircraft management system 1.

In subsequent step S41, the departure time pushing-back confirmation section 20 determines whether or not the departure time pushing-back approval information DTp transmitted from the first user terminal 51 is received. The departure time pushing-back confirmation section 20 moves the process to step S42 when the departure time pushing-back approval information DTp is received, and moves the process to step S6 in FIG. 4 when the departure time pushing-back approval information DTp is not received.

In step S42, the departure time pushing-back confirmation section 20 transmits, to the second user terminal 52, departure time pushing-back guidance information DTa2 to inquire whether or not pushing back of the departure time of the first flight FL1 is desired. The departure time pushing-back guidance information DTa2 includes information on a ground transportation that is available from the port Fa1, which is the arrival point of the first flight FL1, and information on an additional fee to be incurred when pushing back of the departure time of the first flight FL1 is requested.

The second user terminal 52 displays a desire confirmation screen 83 to confirm whether or not pushing back of the departure time is desired, in response to reception of the departure time pushing-back guidance information DTa2, and the second user U2 confirms the desire confirmation screen 83 and performs an operation of choosing whether or not to desire pushing back of the departure time of the first flight FL1. Displayed on the desire confirmation screen 83 is information involved when the departure time of the first flight FL1 is pushed back (from 10:00 to 10:20) as shown in FIG. 2, and the information includes the ground transportation 180 that is traveling means available to the second user U2 from the port Fa1, which is the arrival point of the first flight FL1, an arrival time (expected arrival time) expected when the second user U2 travels from the port Fa1 up to the final destination point Da2 by using the ground transportation 180, and the additional fee required to push back the departure time. When the second user U2 performs an operation of desiring pushing back of the departure time, departure time pushing-back request information DTr is transmitted from the second user terminal 52 to the aircraft management system 1.

In subsequent step S43, the departure time pushing-back confirmation section 20 determines whether or not the departure time pushing-back request information DTr is received from the second user terminal 52. The departure time pushing-back confirmation section 20 moves the process to step S44 when the departure time pushing-back request information DTr is received, and moves the process to step S6 in FIG. 4 when the departure time pushing-back request information DTr is not received.

In step S44, the departure time pushing-back confirmation section 20 transmits, to the first user terminal 51 and the second user terminal 52, departure time pushing-back execution information notifying that pushing back of the departure time of the first flight FL1 will be executed. In next step S45, the departure time pushing-back arrangement section 21 arranges pushing back of the departure time of the first flight FL1. Thus, in the example shown in FIG. 2, the departure time of the first flight FL1 is pushed back from 10:00 to 10:20. Note that pushing back of the departure time of the first flight FL1 may be permitted on condition that a next scheduled flight of the aircraft 100 that is used for the first flight FL1 (see FIG. 2) is not affected even if the departure time of the first flight FL1 is pushed back.

### 4. Other Embodiments

In the embodiment, the aircraft management system 1 is configured by using the computer system that communicates with the first user terminal 51 and the second user terminal 52 via the communication network 300. As another embodiment, the aircraft management system 1 may be included in the first user terminal 51. In such a case, the first user terminal 51 is configured to acquire the schedule information Sif on the first user U1 and the second user U2 from the schedule DB 211, to acquire the ground transportation operation status information Gif from the ground transportation operation status DB, and to acquire the flight status information from an external management system that manages flights.

In the embodiment, the aircraft management system 1 includes the departure time moving-forward confirmation section 18, the departure time moving-forward arrangement section 19, the departure time pushing-back confirmation section 20, and the departure time pushing-back arrangement section 21, and the processes corresponding to moving forward and pushing back of the departure time of the first flight FL1 are performed. As another embodiment, only the departure time moving-forward confirmation section 18 and the departure time moving-forward arrangement section 19 may be included, and only the processes corresponding to moving forward of the departure time may be performed. Only the departure time pushing-back confirmation section 20 and the departure time pushing-back arrangement section 21 may be included, and only the processes corresponding to pushing back of the departure time may be performed.

The process of arranging moving forward of the departure time of the first flight FL1 in response to early arrival of the first user U1 at the port Fs, which is the departure point of the first flight FL1, as shown in FIG. 1 may be executed on condition that an arrival time expected when the first user U1 travels over the traveling route GR1 from the port Fa1, which is the arrival point of the first flight FL1, up to the final destination point Da1 by using the ground transportation 150 becomes earlier (from 11:50 to 11:30 in FIG. 1) as a result of the departure time being moved forward.

The process of arranging pushing back of the departure time of the first flight FL1 in response to late arrival of the second user U2 at the port Fs, which is the departure point of the first flight FL1, as shown in FIG. 2 may be executed on condition that even if the departure time is pushed back, the first user U1 can arrive at the final destination point Da1 by the scheduled arrival time (11:50 in FIG. 1) without delay by traveling over the traveling route GR3 from the port Fa1, which is the arrival point of the first flight FL1, up to the final destination point Da1 by using the ground transportation 170.

In the embodiment, the ground transportation operation status information acquisition section 14 and the target ground transportation recognition section 15 are included, and information on a ground transportation that is available from an arrival point of a flight is transmitted to the first user terminal 51 or the second user terminal 52. As another embodiment, a configuration may be made such that the transmission of information on a ground transportation is not performed, by omission of the ground transportation operation status information acquisition section 14 and the target ground transportation recognition section 15.

Note that FIG. 3 is a schematic diagram showing the functional components of the aircraft management system 1 as a result of segmentation based on the main processes in order to facilitate the understanding of the invention of the present application, and the configuration of the aircraft management system 1 may be segmented based on other categories. A process by each constituent element may be executed by a single hardware unit, or may be executed by a plurality of hardware units. The processes by the individual constituted elements shown in FIGS. 4 to 6 may be executed by using a single program, or may be executed by using a plurality of programs.

### 5. Configurations Supported by the Embodiment

The embodiment is a specific example of configurations described below.

(Configuration 1) An aircraft management system including: a traveling plan recognition section that recognizes a traveling plan of a first user, based on schedule information on the first user, the schedule information being transmitted from a first user terminal used by the first user; a first user arrival time recognition section that recognizes a first user arrival time when the traveling plan includes traveling via a target flight from a first point to a second point, the first user arrival time being a time at which the first user arrives at the first point; a departure time moving-forward confirmation section that transmits departure time moving-forward confirmation information to the first user terminal when a wait time from the first user arrival time until a scheduled departure time of the target flight from the first point is a first predetermined time period or more, the departure time moving-forward confirmation information inquiring whether or not it is desired to move forward the departure time of the target flight; and a departure time moving-forward arrangement section that arranges moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

According to the aircraft management system in configuration 1, when the first user arrives early at the departure point of the target flight, it is possible to support the first user in efficient traveling via aircraft by providing a response of moving forward the departure time of the target flight.

(Configuration 2) The aircraft management system according to configuration 1, further including: a ground transportation operation status information acquisition section that acquires ground transportation operation status information indicating operation status of a ground transportation that is available for traveling from the second point; and a target ground transportation recognition section that recognizes a target ground transportation, based on the traveling plan and the ground transportation operation status information, the target ground transportation being available over a traveling route from the second point to a destination in the traveling plan, wherein the departure time moving-forward confirmation section transmits, to the first user terminal, the departure time moving-forward confirmation information including information on the target ground transportation.

According to the aircraft management system in configuration 2, by providing the first user with the operation status information on the ground transportation from the arrival point of the target flight, the first user is enabled to consider whether or not to request moving forward of the departure time of the first flight, with total traveling via the target flight and the ground transportation taken into account.

(Configuration 3) The aircraft management system according to configuration 1 or 2, further including: a flight status information acquisition section that acquires flight status information indicating flight status of a flight from the first point to the second point; and an alternative flight checking section that checks, based on the flight status information, whether or not it is possible to arrange an alternative flight of the target flight for a second user who has booked use of the target flight, wherein the departure time moving-forward confirmation section transmits the departure time moving-forward confirmation information to the first user terminal when it is confirmed by the alternative flight checking section that it is possible to arrange the alternative flight for the second user.

According to the aircraft management system in configuration 3, it is possible to reduce detriment that the second user, who has booked the target flight, may suffer as a result of the departure time of the target flight being moved forward.

(Configuration 4) The aircraft management system according to any one of configurations 1 to 3, wherein the departure time moving-forward confirmation section transmits, to the first user terminal, the departure time moving-forward confirmation information including information on an additional fee to be incurred when the target flight is used with the departure time being moved forward.

According to the aircraft management system in configuration 4, it is possible to allow the first user to recognize in advance that an additional fee is incurred when the departure time of the target flight is moved forward.

(Configuration 5) An aircraft management system including: a traveling plan recognition section that recognizes a traveling plan of a first user, based on schedule information on the first user, the schedule information being transmitted from a first user terminal used by the first user; a first user arrival time recognition section that recognizes a first user arrival time when the traveling plan includes traveling via a target flight from a first point to a second point, the first user arrival time being a time at which the first user arrives at the first point; a second user arrival time recognition section that recognizes a second user arrival time that is a time at which a second user arrives at the first point, the second user having booked use of the target flight; a departure time pushing-back confirmation section that transmits departure time pushing-back confirmation information to the first user terminal when a delay time from a scheduled departure time of the target flight from the first point until the second user arrival time is a second predetermined time period or more, the departure time pushing-back confirmation information inquiring whether or not it is permitted to push back the departure time of the target flight according to the delay time; and a departure time pushing-back arrangement section that arranges pushing back of the departure time of the target flight when departure time pushing-back approval information is received, the departure time pushing-back approval information being transmitted from the first user terminal in response to reception of the departure time pushing-back confirmation information, the departure time pushing-back approval information approving pushing back of the departure time of the target flight.

According to the aircraft management system in configuration 5, when a delay occurs in arrival of the second user, the departure time of the target flight is pushed back on condition of approval from the first user, whereby it is possible to avoid the departure time being pushed back against unwillingness of the first user, and to support the first user in efficient traveling via aircraft.

(Configuration 6) The aircraft management system according to configuration 5, further including: a ground transportation operation status information acquisition section that acquires ground transportation operation status information indicating operation status of a ground transportation that is available for traveling from the second point; and a target ground transportation recognition section that recognizes a target ground transportation, based on the traveling plan and the ground transportation operation status information, the target ground transportation being available over a traveling route from the second point to a destination in the traveling plan, wherein the departure time pushing-back confirmation section transmits, to the first user terminal, the departure time pushing-back confirmation information including information on the target ground transportation.

According to the aircraft management system in configuration 6, by providing the first user with the operation status information on the ground transportation from the arrival point of the target flight, the first user is enabled to consider whether or not to approve pushing back of the departure time of the first flight, with total traveling via the target flight and the ground transportation taken into account.

(Configuration 7) The aircraft management system according to configuration 5 or 6, wherein the departure time pushing-back confirmation section transmits, to the first user terminal, the departure time pushing-back confirmation information including information on an incentive to be gained when the target flight is used with the departure time being pushed back.

According to the aircraft management system in configuration 7, it is possible to allow the first user to recognize in advance that an incentive can be gained by approving pushing back of the departure time of the target flight.

(Configuration 8) An aircraft management method executed by a computer, including: a traveling plan recognition step of recognizing a traveling plan of a first user, based on schedule information on the first user, the schedule information being transmitted from a first user terminal used by the first user; a first user arrival time recognition step of recognizing a first user arrival time when the traveling plan includes traveling via a target flight from a first point to a second point, the first user arrival time being a time at which the first user arrives at the first point; a departure time moving-forward confirmation step of transmitting departure time moving-forward confirmation information to the first user terminal when a wait time from the first user arrival time until a scheduled departure time of the target flight from the first point is a first predetermined time period or more, the departure time moving-forward confirmation information inquiring whether or not it is desired to move forward the departure time of the target flight; and a departure time moving-forward arrangement step of arranging moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

By causing a computer to execute the aircraft management method in configuration 8, operations and effects similar to those of the aircraft management system in configuration 1 can be brought about.

(Configuration 9) An aircraft management method executed by a computer, including: a traveling plan recognition step of recognizing a traveling plan of a first user, based on schedule information on the first user, the schedule information being transmitted from a first user terminal used by the first user; a first user arrival time recognition step of recognizing a first user arrival time when the traveling plan includes traveling via a target flight from a first point to a second point, the first user arrival time being a time at which the first user arrives at the first point; a second user arrival time recognition step of recognizing a second user arrival time that is a time at which a second user arrives at the first point, the second user having booked use of the target flight; a departure time pushing-back confirmation step of transmitting departure time pushing-back confirmation information to the first user terminal when a delay time from a scheduled departure time of the target flight from the first point until the second user arrival time is a second predetermined time period or more, the departure time pushing-back confirmation information inquiring whether or not it is permitted to push back the departure time of the target flight according to the delay time; and a departure time pushing-back arrangement step of arranging pushing back of the departure time of the target flight when departure time pushing-back approval information is received, the departure time pushing-back approval information being transmitted from the first user terminal in response to reception of the departure time pushing-back confirmation information, the departure time pushing-back approval information approving pushing back of the departure time of the target flight.

By causing a computer to execute the aircraft management method in configuration 9, operations and effects similar to those of the aircraft management system in configuration 5 can be brought about.

### REFERENCE SIGNS LIST

1 aircraft management system, 10 processor, 11 traveling plan recognition section, 12 first user arrival time recognition section, 13 second user arrival time recognition section, 14 ground transportation operation status information acquisition section, 15 target ground transportation recognition section, 16 flight status information acquisition section, 17 alternative flight checking section, 18 departure time moving-forward confirmation section, 19 departure time moving-forward arrangement section, 20 departure time pushing-back confirmation section, 21 departure time pushing-back arrangement section, 30 memory, 31 program, 32 flight status DB, 51 first user terminal, 52 second user terminal, 100 aircraft (for first flight), 110 aircraft (for second flight), 150, 160 target ground transportation, 200 ground transportation management system, 201 ground transportation operation status DB, 210 schedule management system, 211 schedule DB, 300 communication network, U1 first user, U2 second user

What is claimed is:

1. An aircraft management system comprising:
a traveling plan recognition section that recognizes a traveling plan of a first user, based on schedule information on the first user, the schedule information being transmitted from a first user terminal used by the first user;
a first user arrival time recognition section that recognizes a first user arrival time when the traveling plan includes traveling via a target flight from a first point to a second point, the first user arrival time being a time at which the first user arrives at the first point;
a departure time moving-forward confirmation section that transmits departure time moving-forward confirmation information to the first user terminal when a wait time from the first user arrival time until a scheduled departure time of the target flight from the first point is a first predetermined time period or more, the departure time moving-forward confirmation information inquiring whether or not it is desired to move forward the departure time of the target flight; and
a departure time moving-forward arrangement section that arranges moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

2. The aircraft management system according to claim 1, further comprising:
a ground transportation operation status information acquisition section that acquires ground transportation operation status information indicating operation status of a ground transportation that is available for traveling from the second point; and
a target ground transportation recognition section that recognizes a target ground transportation, based on the traveling plan and the ground transportation operation status information, the target ground transportation being available over a traveling route from the second point to a destination in the traveling plan,
wherein the departure time moving-forward confirmation section transmits, to the first user terminal, the departure time moving-forward confirmation information including information on the target ground transportation.

3. The aircraft management system according to claim 1, further comprising:
a flight status information acquisition section that acquires flight status information indicating flight status of a flight from the first point to the second point; and
an alternative flight checking section that checks, based on the flight status information, whether or not it is possible to arrange an alternative flight of the target flight for a second user who has booked use of the target flight,
wherein the departure time moving-forward confirmation section transmits the departure time moving-forward confirmation information to the first user terminal when it is confirmed by the alternative flight checking section that it is possible to arrange the alternative flight for the second user.

4. The aircraft management system according to claim 1, wherein the departure time moving-forward confirmation section transmits, to the first user terminal, the departure time moving-forward confirmation information including information on an additional fee to be incurred when the target flight is used with the departure time being moved forward.

5. An aircraft management system comprising:
a traveling plan recognition section that recognizes a traveling plan of a first user, based on schedule information on the first user, the schedule information being transmitted from a first user terminal used by the first user;
a first user arrival time recognition section that recognizes a first user arrival time when the traveling plan includes traveling via a target flight from a first point to a second point, the first user arrival time being a time at which the first user arrives at the first point;
a second user arrival time recognition section that recognizes a second user arrival time that is a time at which a second user arrives at the first point, the second user having booked use of the target flight;
a departure time pushing-back confirmation section that transmits departure time pushing-back confirmation information to the first user terminal when a delay time from a scheduled departure time of the target flight from the first point until the second user arrival time is a second predetermined time period or more, the departure time pushing-back confirmation information inquiring whether or not it is permitted to push back the departure time of the target flight according to the delay time; and
a departure time pushing-back arrangement section that arranges pushing back of the departure time of the target flight when departure time pushing-back approval information is received, the departure time pushing-back approval information being transmitted from the first user terminal in response to reception of the departure time pushing-back confirmation information, the departure time pushing-back approval information approving pushing back of the departure time of the target flight.

6. The aircraft management system according to claim 5, further comprising:
a ground transportation operation status information acquisition section that acquires ground transportation operation status information indicating operation status of a ground transportation that is available for traveling from the second point; and
a target ground transportation recognition section that recognizes a target ground transportation, based on the traveling plan and the ground transportation operation status information, the target ground transportation being available over a traveling route from the second point to a destination in the traveling plan,
wherein the departure time pushing-back confirmation section transmits, to the first user terminal, the departure time pushing-back confirmation information including information on the target ground transportation.

7. The aircraft management system according to claim 5, wherein the departure time pushing-back confirmation section transmits, to the first user terminal, the departure time pushing-back confirmation information including information on an incentive to be gained when the target flight is used with the departure time being pushed back.

8. An aircraft management method executed by a computer, comprising:
a traveling plan recognition step of recognizing a traveling plan of a first user, based on schedule information on the first user, the schedule information being transmitted from a first user terminal used by the first user;
a first user arrival time recognition step of recognizing a first user arrival time when the traveling plan includes traveling via a target flight from a first point to a second point, the first user arrival time being a time at which the first user arrives at the first point;
a departure time moving-forward confirmation step of transmitting departure time moving-forward confirmation information to the first user terminal when a wait time from the first user arrival time until a scheduled departure time of the target flight from the first point is a first predetermined time period or more, the departure time moving-forward confirmation information inquiring whether or not it is desired to move forward the departure time of the target flight; and
a departure time moving-forward arrangement step of arranging moving forward of the departure time of the target flight when departure time moving-forward request information is received, the departure time moving-forward request information being transmitted from the first user terminal in response to reception of the departure time moving-forward confirmation information, the departure time moving-forward request information requesting moving forward of the departure time of the target flight.

9. An aircraft management method executed by a computer, comprising:
a traveling plan recognition step of recognizing a traveling plan of a first user, based on schedule information on the first user, the schedule information being transmitted from a first user terminal used by the first user;
a first user arrival time recognition step of recognizing a first user arrival time when the traveling plan includes traveling via a target flight from a first point to a second point, the first user arrival time being a time at which the first user arrives at the first point;
a second user arrival time recognition step of recognizing a second user arrival time that is a time at which a second user arrives at the first point, the second user having booked use of the target flight;
a departure time pushing-back confirmation step of transmitting departure time pushing-back confirmation information to the first user terminal when a delay time from a scheduled departure time of the target flight from the first point until the second user arrival time is a second predetermined time period or more, the departure time pushing-back confirmation information inquiring whether or not it is permitted to push back the departure time of the target flight according to the delay time; and
a departure time pushing-back arrangement step of arranging pushing back of the departure time of the target flight when departure time pushing-back approval information is received, the departure time pushing-back approval information being transmitted from the first user terminal in response to reception of the departure time pushing-back confirmation information, the departure time pushing-back approval information approving pushing back of the departure time of the target flight.
